(19) United States
(12) Patent Application Publication
(10) Pub. No.: US 2024/0022442 A1
(43) Pub. Date: Jan. 18, 2024

(54) USING X.509 AND BLOCKCHAIN TO PROVIDE A TECHNOLOGY PLATFORM THROUGH WHICH USERS MAY SECURELY POST DIGITAL INFORMATION, INTO A SYSTEM AND TO COMMENT ON, SUPPLEMENT, DIGITALLY ASSOCIATE THEIR INFORMATION WITH PREVIOUSLY POSTED INFORMATION USING T-TAGS AND TO SUPPORT AND ORGANIZE POSTED INFORMATION WITH A COMMUNITY OF USERS TO SUGGEST OR ESTABLISH TRUSTWORTHY AND/OR AGREED UPON REALITIES FOR MULTIPLE INFORMATION CATEGORIES AND TOPICS

(71) Applicant: TRUSTEDPEDIA, INC., Dover, DE (US)

(72) Inventors: David William Kravitz, San Jose, CA (US); Donald Houston Graham, III, Clearwater, FL (US)

(21) Appl. No.: 18/226,357

(22) Filed: Jul. 26, 2023

Related U.S. Application Data
(60) Provisional application No. 63/436,405, filed on Dec. 30, 2022.
(60) Provisional application No. 63/392,236, filed on Jul. 26, 2022.

(51) Int. Cl. H04L 9/00; G06F 16/901

(52) U.S. Cl. CPC H04L 9/50; G06F 16/9024

(57) ABSTRACT

A system for authenticated users collaborating to post their content using digitally signed, formatted objects following a pedia-type format using blockchain. Users will attest their object content as: a fact; an opinion; a comment; or other. Users will use the system's formatted digital t-tags to associate all or a portion of one posted object, to all or a portion of another object. T-tags may identify, map, associate and otherwise organize data and establish relationships of designated content in a manner that supports collaboration and enlightenment amongst users. Users may assign relative importances to data to support other users' abilities to evaluate that data to reach intelligent conclusions. The system will: score both trust and reputation of both users and data; mitigate against malicious, misleading or false data; have active defenses against “misinformation”, “conspiracy theories”, false “PR” narratives, system “plants”, spoofing of user identities, and more.

### FIELD OF THE INVENTION

The disclosed invention generally relates to preferably user-driven collaboration of digital information typically stored on cloud servers with, in one embodiment the incorporation of blockchain technology to support preferably data immutability along with other benefits generally accepted as typical with the use of blockchain technology. In a preferred format, a public face of such a platform could have some apparent similarity to an electronic encyclopedia. One existing example of a public-facing cloud platform offering an electronic encyclopedia format could be Wikipedia. For the purposes of this application, the platform being described herein is typically referred to as the system.

### OVERVIEW

The system will generally appear as a cloud platform accessible to its users over the Internet or possibly through another network connection. Some users will typically only view available system information while other users may become known to the system and may gain rights to submit data to the systems. Users may typically enter data into the system by associating it in alignment with a system category organizational arrangement. User submitted data entry may preferably be provided in the form of signed, digital objects provided by individual users. The system will typically provide a digital template for users to follow in their submission process. The system may or may not have a data curation process. The system may or may not incorporate moderators for categories (or other subdivisions of stored information).

Users may typically interface with the system by using a system provided software app and/or device, a system approved or recommended software app and/or device or alternately a browser or other method. In one embodiment, an app may preferably support an authentication process that results in a preferably unique and preferably unspoofable identity and/or persona for a user. Users may typically establish one or more actual or pseudonymous identity for their use on the system. An app may preferably have or support or be associated with a device root of trust capability, which operating together may also preferably support encryption and/or digital signing capabilities. In some cases, a digital wallet may partially or fully suffice for an associated a device root of trust capability. An app, possibly in combination with an associated device root of trust capability preferably will have or support a capability of creating and/or signing digital objects as generally described herein. In another embodiment an app could be a browser plug in. In another embodiment, an example of a generally acceptable app could be one created by TrustCentral (www.trustcentral.com) with possibly some modifications for use with the system. Preferably the app could support a digital wallet or possibly associate with a system supported digital wallet as a method of optionally providing digital verification, signing and/or other functions supporting user interaction with the system as described herein.

### Objects

An object for the system is generally a digital package of information created by a user for posting to the system. An object preferably may have a system prescribed format and incorporate various fields, in one embodiment: object name and/or title (typically user created) and subject or topic associated with the object. Other fields could be one or more types of entry, or other. In one embodiment of a type of entry for which a user may submit an object could include a criteria field selection with a choice of acceptable system selectable criteria, such as a comment, an opinion, a fact or other. With such criteria fields preferably be in common amongst objects across much of the system, then preferably users may be able to query, analyze, select or use such criteria selection in other ways for purposes that may be desirable to users and/or the system. The system may preferably create a global unique ID (GUID) to be associated with an object and such GUID may typically be provided to the user, preferably in the form of a certificate, for association with an object prior to the user digitally signing the object (or in another embodiment, possibly provided by the system for the object, possibly in combination with a system digital signature).

### Object Categories

Categories preferably could include a method of assigning groupings associated with system entries and preferably for future association/linkage with other the system objects or entries (such associated system groupings could be somewhat comparable to a press release in which associated “Distribution Channels” may be listed; also possibly comparable to a book release or publication that may associate the book with various “categories” or “topics”). In one embodiment, a user may make selections from a list of existing system categories; (if a desired category does not yet exist, possibly a provisional category is created by the user which may not become official until it becomes approved or possibly modified or substituted for by the system. In another embodiment the system may create a new category or chose to associate the object to an existing category. Typically multiple categories may be completed for an object. The system may establish reference categories and/or reference links that may be used by a user and included with an object.

### Object Content and T-Tags

Object content may typically be established as being one or more of: text; audio; video; graphical; or other formats as may be determined as acceptable within the system. The content within an object may include t-tags. (Note that t-tag is a new term used in this application for the first time to describe a t-tag herein; the term t-tag also refers to what was previously described as simply a tag in provisional applications 63/436,405 and 63/392,236 for which this application claims benefit.) A t-tag preferably may identify two or more references within objects (and in another embodiment identify a reference external to the system). At least one will be a digital reference associated with a specific point or passage or portion or entirety of a source object that may have been provided by that user or an object created by another user. A second t-tag reference will preferably be a selection within another user's object (or in another embodiment, a system posted object) that has been preferably previously processed and posted within the system. In one embodiment a t-tag may be used by a subsequent user to determine and/or identify and/or locate a referenced point, passage, portion of content or other within a preferably posted system object, and preferably determine in the opinion of the user that there is possible association, linkage or other relationship between that object to another system object, portion thereof, or elsewhere, (including in another embodiment to a source external to the system). Preferably there may be no limit as to the number of t-tags created that maybe associated with an object as well as the number of t-tag relationships preferably being associated with any other object and/or portion thereof.

### System Handlings of Objects

A hash of signed, preferably accepted object may typically be created by the system and be associated with the object. In one embodiment, a hash of an object (preferably with associated identifying information) may be written to a blockchain (in one embodiment, an Ethereum blockchain) and typically an associated object may also be recorded in a database. Preferably a directory of blockchain hash records, typically together with their association to database-recorded objects, may be created and maintained. Preferably an object may be stored in a database (for one example, an InterPlanetary File system, or IPFS database) and generally in association with its category or categories, and preferably together with any object-contained reference categories and preferably with any associations to referenced links and/or t-tags. Accepted objects with their hashes may preferably also be backed up to one or more separate, backup databases, generally at one or more other locations.

### System Handlings of T-Tags

Preferably similarly, a hash of signed, preferably completed t-tag may typically be created by the system and be associated with the t-tag. In one embodiment, t-tag hashes may be handled similarly to those of system objects. In another embodiment t-tags or t-tag hashes may be incorporated with or into X.509 certificates. In one embodiment these may be done using transaction certificates in a similar or comparable manner as described by Ghassan Karame and Elli Androulaki in their book entitled “Bitcoin and Blockchain Security”. In another embodiment t-tag association with certificates these may be executed using transaction certificates in a similar or comparable manner as described by Dr. David Kravitz in his IEEE paper entitled “Transaction Immutability and Reputation Traceability: Blockchain as a Platform for Access-controlled IoT and Human Interactivity.” In another embodiment t-tag association with certificates these may be executed using attribute certificates. Other embodiments of incorporating t-tag information into use by the system may be considered.

### User Types and Monetization

Preferably there may be different types of users. In one embodiment, viewing-only users might typically participate using a supported browser (but in another embodiment may also use an app or other). Viewing-only users could typically only be able to view system-allowed content and likely not post and likely not purchase or subscribe to content within the system. Viewable content and possibly other features may be restricted for viewing-only users. In one embodiment, viewing-only users may be described as is generally referred to as a “freemium” use case, typically meaning they pay no fees and generally may have less privileges than other users. Viewing-only user types could preferably be upgradable to other types of users.

Another type of user could be a participating user, while possibly also using a browser, preferably they should typically use an app. While having also having viewing rights, a participating user could typically may have an ability to gain access to content (any/or other offerings) through the system that typically could not be available to a viewing user. In one embodiment, such access additional could be granted for payment of monetary, subscription and/or another form of acceptable exchange to the system and/or to another user monetizing that user's-controlled content, objects, etc. Payments may be made in a variety of manners, including via digital wallet, credit card and/or other methods.

In different embodiments, different levels of access might be, in one embodiment:
“All-you-can-eat”—generally, unlimited consumption for an agreed upon exchange
“Subscription”, in one embodiment by payment for access to specific authors, topics, reports, analyses or other
“Pay-as-you-go”, in one embodiment open access with exchange being charged or paid for a variety of increments of quantity or type of consumption
“More” in one embodiment, when a user reads a portion of a posting, up to limit point when a “more” button or other selection mechanism may be presented, which when accepted such user, may typically provide the user with one or more choices and incur an additional charge or other debit method to that user together with granting access to the additional content
“By designated/selected content” when, in one embodiment charges may be incurred for access to specified and/or selected content

In other embodiments, users may purchase items offered for sale through the system, such as books and/or publications and/or other.

In other embodiments, charges may be paid for access to a designated category of information or other possible subdivision(s) of system content. Other monetization methods may be employed by the system as well.

Fees for access to system content may be partially determined based on a trust score or reputation score of the requesting user and/or a trust score or reputation score of the provider of the requested content and/or a trust score or reputation score of the requested content or other method.

### Groups and Subgroups

Users may be organized into groups of users. Groups of users may be organized into subgroups of users. Groups and subgroups may preferably be established using authentication methods, certificates and/or related technologies (in other embodiments, X.509 certificates and/or other methods may be used). Groups and subgroups may operate or follow constraints according to rules and/or agreements. In another embodiment, the system may adopt or use group and subgroup technology originally designed by TrustCentral (www.trustcentral.com).

### Trust and Reputation Scoring

Preferably by user and/or possibly object and/or possibly by other criteria, a Trust Score (and possibly a Reputation Score) may be assigned. In some embodiments such scores may be manually established and/or adjusted based on observation of user activities and/or actions and/or posted object content and/or other characteristics. In other embodiments, such scores may be calculated through one or more algorithms based on activities of users, there actions with data, data quality, data or user acceptance, use, approval or other metrics that may become available to the system.

The system may incorporate a variety of scoring metrics. Metrics may be scored on a variety of system metrics. In various embodiments, metrics may be, in one embodiment:
Quantity of, usefulness of, t-tags between user or system posted objects, content, t-tags, etc., and preferably as reflected and/or reacted to through t-tags or comments made by other users and/or the system
Negative t-tags or comments or reactions to a user's objects, content, t-tags, etc., by other users and/or the system
Whether and/or how posted “facts” may be validated or contradicted or commented upon by other users and/or the system
In one embodiment, users may be required to align with system-specified definitions of terms being used. For example, a “fact” could be defined as something that can be proven to exist by visible evidence. In such a case, a statement of “two plus two equals four” could generally not meet that definition of “fact” unless it were accompanied by visible evidence of such (in one embodiment what is often referred to as a mathematical “proof”) or linked to visible evidence posted within in the system, preferably through the use of one or more t-tags or through some other reliable method.
In another embodiment whether posted “opinions” may be promoted and/or challenged and/or validated and/or contradicted and/or commented upon by other users and/or the system
In another embodiment whether posted “comments” receive positive or negative engagement by other users and/or the system
In another embodiment considering the quantity and/or duration of views of one's posted objects by other users and/or the system
In another embodiment considering other user engagement in categories in which a user may be engaged (e.g., do other users care about the categories in which the user is participating)
In another embodiment considering possible user feedback and/or survey responses on content, categories, other users and/or the system and/or other
Other metrics that may be found to be of value with in the system In another embodiment, the system may adopt or use trust and reputation scoring technology of users, user activities, and/or user data through methods originally designed by TrustCentral (www.trustcentral.com) or similar thereto.

### Coordinated Curation

In some embodiments it is possible that users may have different viewpoints and/or disagreements as to what may or may not be a “fact” and/or what may or may not be a more or less accurate “opinion” or other disagreement regarding the data of one or more objects and/or representations made within one or more objects. The system may preferably endeavor to establish coordinated curation and/or resolution of such. In one embodiment the system administrators (or possibly an individual or group responsible for a topic) may make a determination to resolve such, or alternatively, possibly offer a debate in one format or another (in one embodiment, a debate that follows a preferably previously identified procedure such as Lincoln-Douglas, Public Forum, Parliamentary or other debate format). In one embodiment, two opposing sides could debate a disputed question. Such a debate might be written or possibly live-streamed and/or recorded for later viewing. In other embodiments, debates may be conducted in written format with stated positions and responses taking place over some established time schedule. Other users (or an approved subset of users) could weigh with their assessment(s) of any arguments made. Possibly a grading system could be established to adjudicate such a dispute and recommend or establish a result. Trust and/or Reputation scores might be incorporated in adjudication decisions.

In another type of curation resolution embodiment, an adjudication may be difficult or uncomfortable to clearly make. One possible outcome might be that single resolution may not be sufficiently easily attainable which could result in a system topic being assigned more than a single entry. In such an embodiment, a topic might then present two or more different perspective entries on a topic. A user later reviewing such a topic could see multiple of such different perspectives listed, preferably with a summary of, or key points of, many listed. Users could then select which perspective (or perspectives) that the user might like to review. Users could vote for preferred perspectives. Results of user selections could be incorporated into a trust or reputation score associated with a posting user and/or of the data of the post or other. User rankings of topic entries could be solicited and/or provided. Any such results could be provided for the benefit of future users.

There could be a hierarchy of user rights, such as in one embodiment, users may need to earn a right and/or otherwise qualify to post objects that may be listed as “facts”. Possibly a user might need to raise their Trust Score and/or Reputation Score to a level that qualifies them to post facts (or other criteria). Other criteria could be employed by the system to raise and/or maintain a quality of postings to the benefit of all users. Preferably, if a user at one point in time, were to be restricted to positing comments and opinions, but not facts, then at a later period of time when that user may have earned a right to post facts, that user may then apply to raise earlier “opinion” posts to “fact” posts (or possibly gradation adjustments of one or the other). A preferably robust system of flexible criteria combined with flexible and/or useful scoring system may enhance the usefulness and benefits of the system for other users.

A preferably valuable tool of the system in such described process is expected to be the t-tags associated with objects, and through t-tags, related objects and/or selections of data within t-tagged objects. Such relationships created and/or documented by t-tags may preferably provide valuable insights for the evaluation of data, users, user activities, and/or other information that could be made available.

### Accessing Records

Records and/or t-tags associated with records may typically be viewable to other users through a browser, through an app, or other through other methods that may be used to view stored internet or database-accessible records. In some embodiments those other users authorized to view or otherwise access an object may be monitored and/or controlled by the system. Users and/or the system may create descriptive and/or graphical reports of objects, associated t-tags, relationships, other noteworthy factors between and/or amongst these which may be documented and in some embodiments may associate with conclusions, opinions and/or other comments by others, preferably with such being provided with appropriate t-tags and/or associated objects.

### Reporting

T-tags also may preferably be referenced by a system index, a system database and/or a system graphical reporting capability or other. An example of a report could be a selection of t-tags associated with a designated subject. In various embodiments for reporting purposes, the system may make use of one or more of t-tags being associated with transaction certificates or attribute certificates.

In one embodiment, a user or the system making a query on a t-tag may preferably receive a report or graphical response or other of t-tagged references associated to such object upon which a report of further and/or more extensive relationships might be queried. In various embodiments, t-tags may be used by the system and/or users to identify, map, associate or otherwise organize and/or display data, information, relationships, designated content, etc., within and, in some embodiments, without the system.

In one embodiment, an object may be created in a format preferably specified by the system. Preferably the object may be digitally signed by a user. The object may be typically posted to the system by a user. In one embodiment, the system may receive an object and inspect it to ensure format compliance with system requirements. Typically, non-complying objects could be returned to the user. Preferably, the category of a complying object together with applicable reference categories and/or reference links that may also be signed by the user, then examined and accepted by the system or not.

### Graphical Display

In one embodiment a graphical (or a non-graphical) user display capability may report and/or display results of a user or system query preferably based on system data, content, t-tags, etc. and/or relationships between them to users and/or the public and/or others. Such graphical display may be presented in a dynamic manner. Graphical relationships may be depicted in commonly seen 2-dimensional format, or preferably in more dynamic 3-dimensional space representations which may, in some embodiments, also dynamically adjust and/or reorganize in real time based on adjustments made preferably through user queries and/or change in parameter determinations and/or the system or other. Preferably many such reports could be done on a manual basis and/or a programmed and/or programmable basis. In one embodiment, the analysis and conn. Enlightenting—discovering—aligning data from multiple sauces to discover what otherwise might remain unknown

### Artificial Intelligence

In one embodiment, objects, object meta data, t-tags, t-tag meta data, object data and other information and analysis thereof, may be used, controlled, queried, reported on by an artificial intelligence capability and/or other entity to analyze and/or draw one or more conclusions and/or perform other actions upon or with such information. Such activities may preferably be controlled and/or monitored by the system which, in another embodiment may be partially or primarily controlled by an artificial intelligence capability.

Artificial intelligence might be used to preferably query one or more aspects of the system and from data obtained from such (and possibly combined with other data from the system and/or other sources, my create new reports, expand on prior reports, repeat prior reports, or by other method, produce reports as described herein or other reports. Reports may be partially based on trust and/or reputation scoring. An AI may create new trust and/or reputation scoring methods and/or algorithms.

### FIGURES

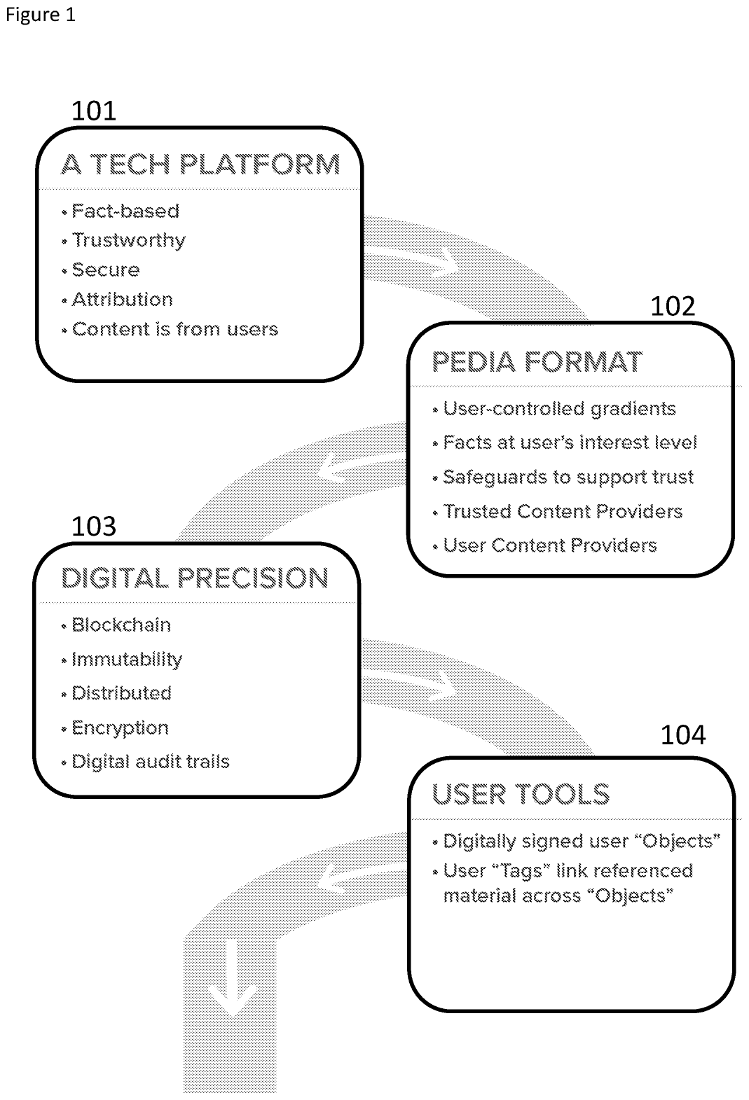

The attached FIG. 1 depicts one embodiment of how users may engage with the system. 101 shows typical characteristics of the system, such as a tech platform with preferably qualities such as being fact-based, trustworthy, secure, providing attribution, and that content is generally from users. 102 shows typical characteristics of the system, such as a tech platform with preferably qualities such as being in a pedia format preferably qualities such as offering user-controlled gradients of features, system tools, etc, that preferably facts could be presented at a user's interest level, that the system provides safeguards designed to support trust, that the system may offer roles to trusted content providers which may be able to offer optional content to users, typically with an associated cost to users as well as content provided by users. With a following characteristic of the system in 103 that the system preferably employs and supports digital precision technologies such blockchain technology, associated data immutability, over distributed databases, combined with appropriate uses of encryption, all of which may typically support digital audit trails. With a following characteristic of the system in 104, preferably providing tools for users, typically such digitally signed user “objects” and user “t-tags” with typically associated referenced material across “objects” in the system.

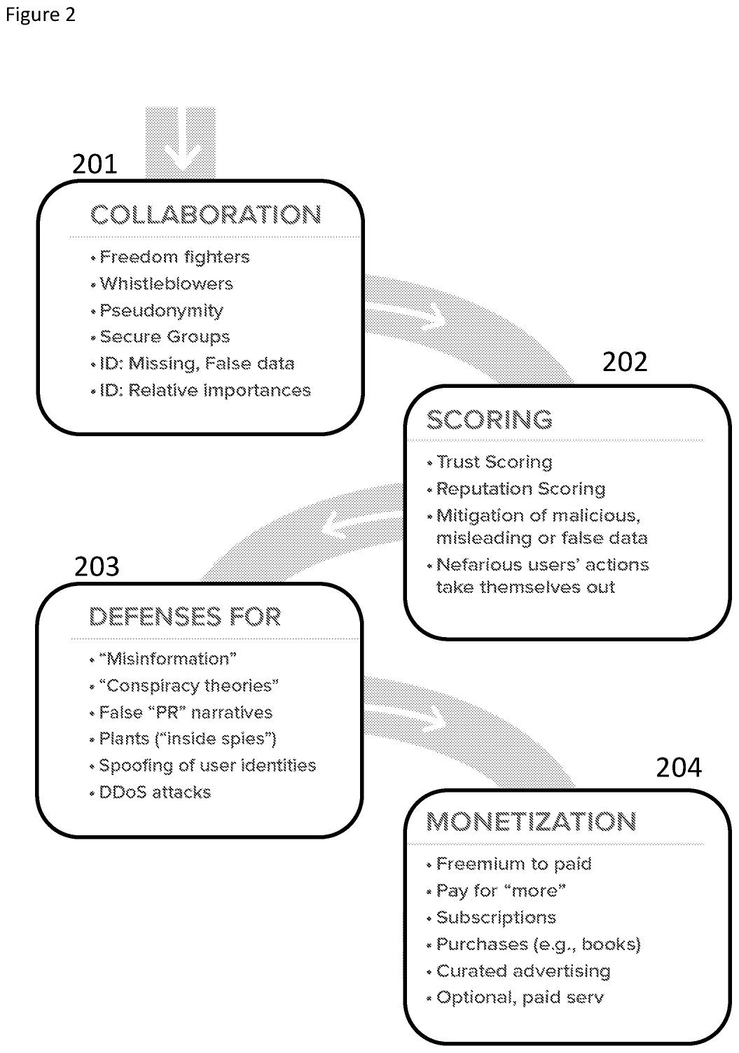

These capabilities track to FIG. 2 which depicts another embodiment of how multiple preferable components of the system might be integrated and preferably how one or more of such components might be associated to compose one or more embodiments of the system. Also discloses examples of how some of the potential results and/or products of the system might be and/or might encompass. For example the system preferably supports collaboration amongst users, with a preferable focus on users who value their freedom and may be willing to fight to maintain it, with a preferable interest to support whistleblowers who may act in support of the general public interest, and where users may optionally benefit from use pseudonymity as to their personal identity, where users may operate preferably within secure groups as they may desire, and where the systems supports capabilities of users to identify missing and/or false data that may posted within the system, and that preferably users may also have an ability to identify and assign relative importances to posted data to support other users abilities to evaluate such data against other data and to preferably support use of the system by preferably providing capabilities to scoring users and/or data through methods such as trust scoring and/or reputation scoring, as well as tools to mitigate risks or harm from malicious, misleading and/or false data that may be posted, and a preferable result from such tools such that nefarious users' actions expose themselves by identifying such, and thus they may effectively take themselves out as trusted members of the system. And further that the system may be preferably enhanced by having defenses for potential harmful actions by others such “Misinformation”, “Conspiracy theories”, forwarding false “PR” narratives, introducing into the system plants (called “inside spies” Sun Tzu), risks from malicious actors spoofing of other user identities, false charges made by bad actors and also mitigation from DDoS attacks that could be launched against the system or elements of it. The system also preferably supports multiple monetization methods such as freemium-to-paid options; options to pay for “more”; subscription options; ability to make purchases (e.g., books); capabilities for curated advertising associated with user interest; and other optional, paid services. The system can preferably provide robust service offerings with all or a portion or combination of such services and features.

1. A method for a user with a user-controlled device, each device including a hardware processor and associated memory, the method comprising:
a system uniquely authenticating a user-controlled device
a system providing a unique identification to that device
the device having digital signing capability
the device creating a digital object in a format approved by the system
the device digitally signing the object
the device transmitting the signed object to the system

2. The method claim 1, wherein other users with user-controlled devices create and post additional objects that are stored in the system

3. The method of claim 1, where the user-controlled device attests that the object is a fact, an opinion, a comment or other

4. The method of claim 1, wherein the system validates the conforming format of the object
the system creating a hash of the object
the system recording the hash of the object on a blockchain
the system storing the object in a database

5. The method claim 4, wherein a user with a user-controlled device views two or more objects stored in the system
in the user's opinion, the user identifies a possible relationship between two objects
the user uses a t-tag in a format acceptable to the system to identify a portion of one object together with its perceived relationship to a portion of a second object
the user-controlled device digitally signs the t-tag
the user-controlled device transmits the signed t-tag to the system

6. The method of claim 5, wherein the system validates the conforming format of the t-tag
the system creating a hash of the t-tag
the system recording the hash of the t-tag on a blockchain
the system storing the t-tag in a database

7. The method of claim 6, wherein the system creates a user-accessible database of objects and t-tags
users may access the system and analyze multiple objects, t-tags and corresponding relationships
users may have the system create a variety of reports based on user-driven or system-driven parameters
users may have the system create a variety of graphical representations of t-tagged identified relationships based on user-driven or system-driven parameters
